(19) United States
(12) Patent Application Publication
(10) Pub. No.: US 2023/0083647 A1
(43) Pub. Date: Mar. 16, 2023

(54) REUSABLE STRUCTURES CONTAINING ISOTOPES FOR SIMULATING RADIOACTIVE CONTAMINATION ENVIRONMENTS, AND METHODS OF FORMATION

(71) Applicant: Battelle Energy Alliance, LLC, Idaho Falls, ID (US)

(72) Inventors: Nicholas R. Mann, Idaho Falls, ID (US); Kevin P. Carney, Idaho Falls, ID (US)

(21) Appl. No.: 17/661,849

(22) Filed: May 3, 2022

Related U.S. Application Data
(60) Provisional application No. 63/261,069, filed on Sep. 10, 2021.

(51) Int. Cl. G21G 4/06; G21F 9/30

(52) U.S. Cl. CPC G21G 4/06; G21F 9/305

(57) ABSTRACT

A structure—for use in simulating radioactive contamination environments—comprises fragments encapsulated within a substrate material. The fragments comprise radioactive isotopes with moderate half-lives. To form such structures, the fragments are encapsulated within the at least one substrate material. In a method of simulating a radioactive contamination environment, multiple removable structures, such as the aforementioned structures, are selectively placed in a facility, and may be subsequently removed, stored, and reused.

### CROSS-REFERENCE TO RELATED APPLICATION

This application claims the benefit under 35 U.S.C. § 119(e) of U.S. Provisional Patent Application Ser. No. 63/261,069, filed Sep. 10, 2021, the disclosure of which is hereby incorporated in its entirety herein by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to training, testing, and research in radioactive contamination environments. More particularly, this disclosure relates to structures—containing radioactive isotopes—that are selectively positionable within a training, testing, or research environment and that are reusable.

### BACKGROUND

The emergency response community trains to be prepared for disaster situations, such as those that might involve the dispersal of radioactive material. To maintain preparedness, emergency response agencies conduct regular training exercises in controlled contamination environments. However, training with actual, dispersed radioactive materials (e.g., materials comprising radioactive isotopes such as Cs-137, Sr-90, U-235, Ir-192) is generally problematic due to the biological and environmental radio-toxicity of these materials.

In some environments, such as indoor facilities, radiopharmaceuticals such as technetium-99m (Tc-99m) (^{99m}Tc) and gallium-68 (Ga-68) (⁶⁸Ga) may be used and distributed—as surrogates for other radioactive isotopes—to create the controlled contamination environment. In outdoor training environments, these or other surrogate materials may be dispersed.

Conventionally, surrogate isotopes are dispersed within a training environment by spraying a liquid solution that includes the surrogate isotopes. Such spray-applied surrogate solutions have limitations as to areas of use and as to removable contamination amounts. The availability of the surrogate isotope materials is also limited. Moreover, once sprayed, the liquid solutions tend to become absorbed into soils and other porous surfaces, which can prohibit accurate sampling and detection of solely the source material. Due to short half-lives of the surrogate isotopes (e.g., 1 hr to 6 hrs), multiple spray applications of the solution may be required throughout a training evolution to provide trainees an adequate contamination dose rate. Also, once sprayed, the surrogate solution cannot be easily retrieved and redistributed in another training facility. Often, the production and use of these short half-life surrogate isotope solutions costs thousands of US dollars.

Accordingly, developing materials suitable for safely and economically simulating radioactive contamination environments continues to present challenges.

### BRIEF SUMMARY

Disclosed is a structure for use in simulating radioactive contamination environments. The structure comprises fragments encapsulated within a substrate material. The fragments comprise radioactive isotopes with half-lives within a range from about one year to about thirty years.

Also disclosed is a method of forming a structure for use in simulating radioactive contamination environments. The method comprises encapsulating fragments within at least one substrate material. The fragments comprise radioactive isotopes with moderate half-lives.

Moreover, disclosed is a method of simulating a radioactive contamination environment. The method comprises selectively placing, in a facility, multiple removable structures. Each of the removable structures comprises fragments encapsulated within a substrate material. The fragments comprise radioactive isotopes with moderate half-lives.

### BRIEF DESCRIPTION OF THE DRAWINGS

FIG. 1A is a schematic, perspective illustration of a structure (herein referred to as a “tile”) containing irradiated particles for use in the simulation of a radioactive contamination environment, in accordance with embodiments of the disclosure.

FIG. 1B is a schematic, top plan illustration of the structure of FIG. 1A.

FIG. 1C is a schematic, side elevation illustration of the structure of FIG. 1A and FIG. 1B.

FIG. 2A is a side elevation, enlarged, cross-sectional illustration of the area designated by box 102 of FIG. 1C, illustrating material of the structure of FIG. 1A, FIG. 1B, and FIG. 1C, wherein the material includes irradiated particles embedded in and dispersed throughout a substrate material, in accordance with embodiments of the disclosure.

FIG. 2B is a side elevation, enlarged, cross-sectional illustration of the area designated by box 102 of FIG. 1C, illustrating material of the structure of FIG. 1A, FIG. 1B, and FIG. 1C, wherein the material includes irradiated particles retained between regions of a substrate material, in accordance with embodiments of the disclosure.

FIG. 3A is a cross-sectional, schematic illustration of an irradiated particle of any of FIG. 2A and FIG. 2B, wherein the irradiated particle is in the form of a matrix-encapsulated particle, in accordance with embodiments of the disclosure.

FIG. 3B is a cross-sectional, schematic illustration of an irradiated particle of any of FIG. 2A and FIG. 2B, wherein the irradiated particle is in the form of a matrix-intermixed fragment, in accordance with embodiments of the disclosure.

FIG. 3C is a cross-sectional, schematic illustration of an irradiated particle of any of FIG. 2A and FIG. 2B, wherein the irradiated particle is in the form of a matrix-intermixed-and-encapsulated fragment, in accordance with embodiments of the disclosure.

FIG. 3D is a cross-sectional, schematic illustration of an irradiated particle of any of FIG. 2A and FIG. 2B, wherein the irradiated particle is in the form of a non-encapsulated particle, in accordance with embodiments of the disclosure.

FIG. 4 is a schematic illustration of a room including the structures of FIG. 1A, FIG. 1B, and FIG. 1C selectively positioned to simulate a radioactive contamination environment for training, testing, and/or research, in accordance with embodiments of the disclosure.

### DETAILED DESCRIPTION

Disclosed are apparatus (e.g., structures, which are herein referred to as “tiles”) for selective distribution in a facility to simulate a radioactive contamination environment. The tiles include isotopes encapsulated within a substrate material. The tiles may be configured to resemble a floor tile, a door mat, a wall hanging, a ceiling tile, area rug, rock, or other selectively positionable structure. One or more of these “tile” structures may be placed throughout a training venue (e.g., a training facility) to produce a realistic contamination environment. With one or more tiles, a relatively large contamination area may be simulated or more point-source contamination areas may be simulated. Upon completion of a training exercise, the tiles may be gathered, stored, and reused in future contamination training events.

As used herein, the term “tile” means and refers to a structure that is selectively positionable and repositionable within an environment. The “tile” may be substantially non-brittle so as to be contactable by other items or individuals (e.g., walked on) without breaking down. Unless otherwise specified, a “tile,” in accordance with embodiments of the disclosure, may be substantially planar or nonplanar, rectangular or round, flat or of varying topography, porous or non-porous, flexible or rigid, and/or singular or in multiple joined parts.

As used herein, the term “particle” means and refers to a solid mass with a largest diameter within a range from about one micron (about 1 μm) to about one centimeter (about 1 cm). Accordingly, the particles, in accordance with embodiments of the disclosure, may not be characterized as “nanoparticles.”

As used herein, the term “fragment” means and refers to a solid mass that includes at least one particle.

As used herein, the term “matrix-encapsulated” means and refers to wholly enclosing, or substantially wholly enclosing, a first material within at least one matrix material. Each individual fragment of matrix-encapsulated material may include one or more particles of the first material within at least one matrix material that wholly encompasses, or substantially wholly encompasses, each of the particle(s).

As used herein, the term “matrix-intermixed” means and refers to a first material being homogeneously or heterogeneously mixed with at least one matrix material, such that the first material may or may not be wholly enclosed, or substantially wholly enclosed, within the at least one matrix material. Each individual fragment of matrix-intermixed material may include more than one distinct region (e.g., phase) of the first material within a continuous region or more than one distinct region of the at least one matrix material.

As used herein, the term “matrix-intermixed-and-encapsulated” means and refers to one or more matrix-intermixed fragments being further encapsulated within at least one matrix material, which may be the same or a different matrix material than the matrix material(s) of the matrix-intermixed fragments.

As used herein, the term “surrogate,” when referring to an isotope or material, means and includes an isotope or material that exhibits the same or substantially similar particular characteristics compared to those particular characteristics exhibited by an isotope or material to be emulated, i.e., by an “emulated” isotope or “emulated” material. Not all characteristics may be exhibited in the same or a similar manner. For example, it is expected that a “surrogate” isotope exhibits a shorter half-life compared to that exhibited by the emulated isotope.

As used herein, the term “high-purity,” when referring to a material, refers to that material comprising at about least 99 at. % (e.g., at about least 99.9 at. %, at least about 99.99 at. %) of the isotope(s), element(s), or compound(s) in question.

As used herein, the term “reactant material” refers to a material to be subjected to irradiation to form an irradiated material.

As used herein, the term “moderate half-life” means and refers to a half-life within a range from about one year (about 1 yr) to about thirty years (about 30 yrs).

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof

As used herein, the term “may,” when used with respect to a material, structure, feature, or method act, indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” and “approximately,” when either is used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, the singular forms “a,” “an,” and “the” are intended to include the plural forms as well, unless the context clearly indicates otherwise.

The following description provides specific details, such as material types and processing conditions, in order to provide a thorough description of embodiments of the disclosed materials and methods. However, a person of ordinary skill in the art will understand that the embodiments of the materials and methods may be practiced without employing these specific details. Indeed, the embodiments of the materials and methods may be practiced in conjunction with conventional techniques employed in the industry.

The processes described herein do not form a complete process flow for the related methods. The remainder of the methods are known to those of ordinary skill in the art. Accordingly, only the methods and conditions necessary to understand embodiments of the present materials and methods are described herein.

The isotope(s) to be used in training (e.g., personnel training), testing (e.g., instrumentation testing), and/or research are incorporated within structures that can be selectively distributed in an environment and then recovered, stored, and reused in subsequent training/testing/research sessions. These isotope-containing structures are referred to herein as “tiles.”

Reference will now be made to the figures, wherein like numerals refer to like components throughout. The drawings are not necessarily drawn to scale.

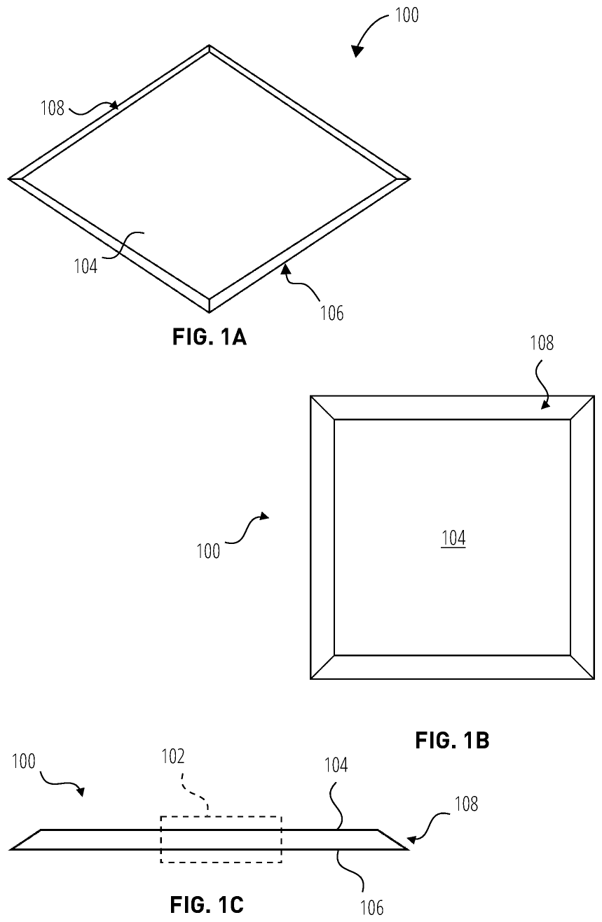

With reference to FIG. 1A through FIG. 1C, illustrated is an example form of a structure, in accordance with embodiments of the disclosure, the structure—referred to herein as a “tile” 100—including radioactive isotopes encapsulated within a robust substrate material. The tile 100 may be substantially flat with an upper surface 104 and/or lower surface 106 that is substantially planar. The tile 100 may be substantially rectangular, and the edges 108 may be angled through their height and relatively straight through their length. However, the disclosure is not limited to this configuration of the tiles 100.

The tile 100 may be structured and configured to resemble a surface structure that may be commonly found in a training environment. For example, in embodiments in which the tiles 100 are to be used in an indoor training facility, the tiles 100 may be fabricated to resemble floor, wall, or ceiling tiles. In some such embodiments, the tiles 100 may be configured to resemble laminate flooring, tile flooring, countertop material, carpet tiles, carpet runners, substantially two-dimensional decorative items, substantially three-dimensional furniture pieces, etc. For tiles 100 to be used in outdoor facilities, the tiles 100 may be shaped and otherwise configured to resemble other outdoor structures, such as sod patches, gravel areas, rocks, fencing material, pavers, etc.

In some embodiments, the edges 108 or other portions of the tile 100 may include features (e.g., tongue-and-groove features, hook-and-loop features) to accommodate selective or permanent interlocking of the tile 100 with an additional one or more of the tiles 100 or with other structures in the facility.

The dimensions of the tiles 100 may also be tailored according to training needs. For example, in some embodiments tiles 100 may be formed with edges 108 that are each about 30.5 cm (about 1 ft) in length. Multiple such tiles 100 may be laid beside one another to provide a contamination area. In other embodiments, a single tile may be formed to be relatively large. For example, one or more tiles 100 may be fabricated to resemble a rug or carpet runner (e.g., with length by width dimensions within a range from about 91 cm by 91 cm (about 3 ft by 3 ft) to about 122 cm by 305 cm (about 4 ft by 10 ft)) that may be laid out along a hallway to simulate contamination throughout that space. In still other embodiments, one or more tiles 100 may be formed to be relatively small (e.g., puck sized) so as to simulate point-source contaminations. Accordingly, each tile 100 may be formed to any desired size big enough to encapsulate the isotope material therein.

In some embodiments, the tiles 100 may be configured to be flexible so that the tiles 100 may be rolled up and stored in rolled format after the training exercise. Therefore, the substrate material of the tile 100 may be selected and configured to accommodate flexing of the tile 100 without the encapsulated radioactive material being exposed to the air.

Moreover, while FIG. 1A through FIG. 1C illustrate tiles 100 with the upper surface 104 that extends across a whole of the tile 100, in other embodiments, the tiles 100 may be fabricated to include openings (e.g., through a thickness of the tile 100) provided the irradiated material in the tile 100 is not exposed by the openings.

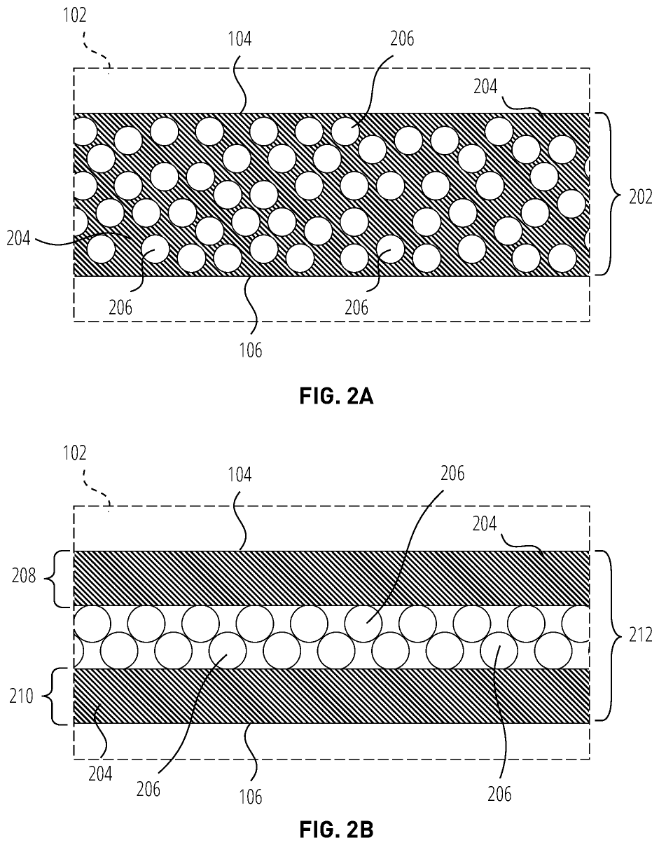

FIG. 2A schematically illustrates an enlarged view of a portion (e.g., box 102 of FIG. 1C) of the tile 100 to illustrate the composition of a tile material 202 from which the tiles 100 may be formed. The tile 100 includes at least one substrate material 204 in which are encapsulated fragments of material that include radioactive isotopes, which fragments are referred to herein as “isotope fragments” 206.

The isotopes, of the isotope fragments 206 encapsulated within the tiles 100, may be selected and/or fabricated to comprise, consist essentially of, or consist of isotopes with moderate half-lives, such as one or more of the following isotopes: europium-152 (Eu-152) (¹⁵²Eu), europium-154 (Eu-154) (¹⁵⁴Eu), selenium-75 (Se-75) (⁷⁵Se), iridium-192 (Ir-192) (¹⁹²Ir), cesium-137 (Cs-137) (¹³⁷Cs), cobalt-60 (Co-60) (⁶⁰Co), and barium-133 (Ba-133) (¹³³Ba). The isotope fragments 206 may be formed so as to be substantially free of isotopes with long half-lives (e.g., half-lives longer than about 30 years) and, at least when the isotope fragments 206 and the tile 100 are initially fabricated, free of isotopes with short half-lives (e.g., half-lives shorter than about 1 year).

Conventionally, there has been no effective way to train using these types of radioactive isotopes. Their properties generally prohibit their use in training other than as sealed sources (e.g., within a sufficiently-tested, sealed, steel container), but there has conventionally not been an effective way to modify or configure sealed sources that would effectively simulate a large-area radiological contamination environment while still permitting complete recovery of the material from the training facility. In accordance with embodiments of the disclosure, however, the isotopes are safely encapsulated in the substrate material 204 and formed into the tile 100 structures that can be selectively distributed within a training facility to simulate an environment that has been radioactively contaminated. At least once encapsulated within the substrate material 204, the isotopes may exhibit low to no biological or environment toxicity. And, the use of the tiles 100 may avoid the use of liquid radioactive contamination solutions and other liquid-form materials.

In some embodiments, the substrate material 204 is formed of and includes, for example and without limitation, a polymer-based material (e.g., an 00000000 polyamide, such as KEVLAR®) in monolithic or woven fiber-based form. In these or other embodiments, the substrate material 204 may be formulated or otherwise configured to be robust (e.g., not brittle) so as to be suitable for years of use. For example, the substrate material 204 may be formulated or otherwise configured to withstand environmental conditions and storage conditions without substantial deterioration.

The substrate material 204 may also be formulated or otherwise configured so as not to attenuate the desired detectable radiological characteristics and signatures of the isotope fragments 206. For example, the substrate material 204 may be selected or formed to have a density that permits detection of the radioactivity of the isotope fragments 206 through the substrate material 204. In some embodiments, the substrate material 204 may attenuate the beta radiation but not the gamma radiation of the isotope fragments 206.

The substrate material 204 may, in some embodiments, also be substantially non-porous (e.g., monolithic regions of the substrate material 204 may be substantially non-porous, or, in embodiments in which the substrate material 204 is a fiber-based material, the fibers themselves may be substantially non-porous, though there may be void space between respective fibers).

In some embodiments, the substrate material 204 may include a polymer (e.g., KEVLAR®) or other moldable material, and the tile 100 may be formed by including the isotope fragments 206 into the polymer material prior to curing. The mixture of polymer material and isotope fragments 206 may be molded, extruded, cured, machined, and/or otherwise shaped into the tile 100 so as to include the isotope fragments 206 dispersed throughout and surrounded by a continuous phase of the polymer substrate material 204, as schematically illustrated for the tile material 202 of FIG. 2A. In other embodiments, the isotope fragments 206 may be embedded in the substrate material 204, such that the illustration of FIG. 2A may represent at least one portion of the tile 100, but the isotope fragments 206 may not be evenly distributed throughout all regions of the tile 100.

In some embodiments, the tile material 202 may include additional material regions. For example, a robust, non-slip polymer material may be included as an upper layer on the tile material 202 to provide a non-slippery walkable surface of the tile 100. Additionally or alternatively, a non-slip region may be included as a lower layer below the tile material 202 to avoid the tile 100 shifting from its location as it is walked upon.

With reference to FIG. 2B, in some embodiments, discrete regions (e.g., first region 208 and second region 210) of the substrate material 204 may be formed and then the isotope fragments 206 retained between the regions (e.g., between the first region 208 above and the second region 210 below). The discrete regions may be joined together (e.g., sealed by methods such as melting, adhering, welding) along the edges 108 (FIG. 1A to FIG. 1C) of the tile 100 to encapsulate the isotope fragments 206 within the tile 100. Though there may or may not be void space between the isotope fragments 206 in the middle region of the tile material 212, the isotope fragments 206 may be encapsulated and held in place by the substrate material 204 of the first region 208 and the second region 210 so that the isotope fragments 206 may not shift when the tile 100 is handled.

In some such embodiments, each of the discrete regions (e.g., the first region 208, the second region 210) may be formed of monolithic regions of the substrate material 204 or of woven fibers of the substrate material 204, and the tile material 212 may be substantially a so-called “sandwich” material.

The tiles 100 may be substantially free (e.g., upon completion of fabrication) of other radioactive isotopes, such as—and without limitation—strontium isotopes (e.g., strontium-90 (Sr-90) (⁹⁰Sr)), uranium isotopes (e.g., uranium-235 (U-235) (²³⁵U)), and plutonium isotopes (plutonium-238 (Pu-238) (²³⁸Pu)). Radiopharmaceuticals, such as technetium-99m (Tc-99m) (^{99m}Tc) and gallium-68 (Ga-68) (⁶⁸Ga), may also be absent from the tiles 100 (e.g., upon completion of fabrication).

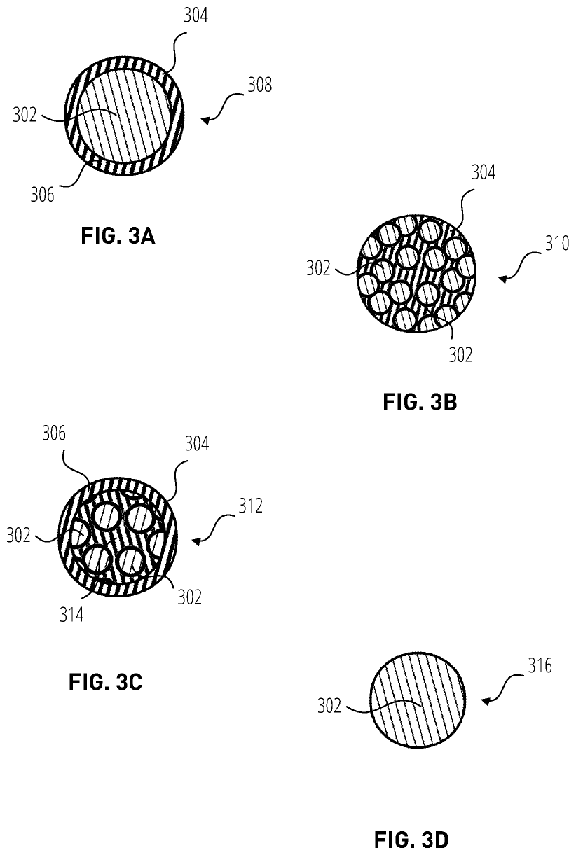

With reference to FIG. 3A to FIG. 3D, illustrated are various forms of the isotope fragments 206 of FIG. 2A and/or FIG. 2B.

With reference to FIG. 3A to FIG. 3C, prior to the radioactive isotope material being encapsulated within the substrate material 204 (FIG. 2A, FIG. 2B) of the tile 100 (FIG. 1A to FIG. 1C), the isotope material—referred to herein and illustrated as irradiated particles 302 (e.g., particles of high-purity isotope material)—may be mixed with or encapsulated within one or more matrix material(s) 304 (e.g., glass, such as high-purity silica glass). At least one particle comprising, consisting essentially of, or consisting of stable, so-called “parent isotope(s)” of the target isotopes may be encapsulated—e.g., by a sol-gel technique—within at least one matrix material 304 and then irradiated to provide the at least one irradiated particle 302 encapsulated in a shell 306 of the matrix material 304. The resulting fragment may be in the form of a matrix-encapsulated particle 308 illustrated in FIG. 3A.

For example, particles of Eu-151 and/or Eu-153—which are reactant materials from which target isotopes Eu-152 and/or Eu-154, respectively, may be derived—may be encapsulated in high-purity silica glass, annealed, and then activated (e.g., by neutron activation) to form at least one irradiated particle 302 of europium isotopes Eu-152 and/or Eu-154 encapsulated within the shell 306 of the matrix material 304. At the time of the initial matrix encapsulation, the particles with the parent isotope(s) may be high-purity particles, and the use of high-purity silica glass as the matrix material 304 may be beneficial for the irradiation to avoid unwanted activation products.

Encapsulation in a glass matrix material (e.g., the matrix material 304) may be performed using known sol-gel synthesis techniques. See, e.g., Carney et al., “The Development of Radioactive Sample Surrogates for Training and Exercises,” Journal of Radioanalytical and Nuclear Chemistry, (2013), 296:769-773; and Carney et al., “The Development of Radioactive Glass Surrogates for Fallout Debris,” Journal of Radioanalytical and Nuclear Chemistry, (2014), 299:363-372, the disclosure of each of which is hereby incorporated herein in its entirety by this reference.

Once encapsulated in the matrix material 304, and, optionally, annealed, the matrix-encapsulated material is irradiated to form the irradiated particles 302 already in the matrix material 304. The irradiation process may use, for example and without limitation, neutron- or photon-induced fission or photonuclear induced reactions (i.e., (γ, Xₙ) and (γ, Xₚ) reactions, wherein “γ” indicates incident gamma rays and “X” indicates a number of neutrons (n) or protons (p) emitted from the parent isotope in the photonuclear reaction). Isolation (e.g., resin extraction) techniques may also be used to remove unwanted materials. With these irradiation and isolation techniques, the desired, target isotopes may be obtained at high-purity levels.

The sol-gel glass encapsulation process may facilitate control of the resulting size of the isotope fragments 206. For example, the size of the solution droplets aliquoted to form the matrix material 304 (e.g., glass) may be controlled to tailor the resulting size of the isotope fragment 206 as the matrix material 304 is being formed to encapsulate the particles that will become the irradiated particles 302. In other embodiments, once the matrix material 304 has been formed and solidified on the particles that will become the irradiated particles 302, the matrix material 304 may be ground or crushed to a smaller, desired size for the isotope fragments 206. In other embodiments, once the particle that will become the irradiated particle 302 is encapsulated in the matrix material 304 shell 306, the resulting matrix-encapsulated particle 308 may be incorporated into the substrate material 204 without further size manipulation. In other embodiments, once encapsulated in the matrix material 304 and irradiated, the resulting matrix-encapsulated particle 308 is crushed or otherwise altered to further tailor the size of the isotope fragments 206 that will be included in the substrate material 204.

The formed matrix-encapsulated particles 308 may then be incorporated into the substrate material 204 to provide the isotope fragments 206 of FIG. 2A or FIG. 2B in the encapsulation form illustrated in FIG. 3A.

With reference to FIG. 3B, in some embodiments, rather than encapsulating individual stable particles in the matrix material 304 to provide the shell 306 around each individual irradiated particle 302, multiple stable isotope particles may be intermixed into the matrix material 304, so that the matrix material 304 binds together multiple particles (e.g., multiple irradiated particles 302 in the resulting isotope fragment 206). Once solidified—and before or after irradiation—the mixture may be crushed or otherwise formed into individual isotope fragments 206 (FIG. 2A, FIG. 2B), which may be in the form of a matrix-intermixed fragment 310 illustrated in FIG. 3B. The matrix material 304 may provide a substantially continuous phase or discrete regions amongst the irradiated particles 302. Void space may or may not be included within the matrix-intermixed fragment 310.

With reference to FIG. 3C, in some embodiments, the matrix-intermixed fragment 310 of FIG. 3B, multiple of the matrix-encapsulated particles 308 of FIG. 3A, or post-crushing fragments formed by any of the aforementioned methods may be further encapsulated in matrix material 304 to form a matrix-intermixed-and-encapsulated fragment 312 that includes the shell 306 and both irradiated particles 302 and additional matrix material 314. The additional matrix material 314 within the core of the matrix-intermixed-and-encapsulated fragment 312 may have the same or different composition than the matrix material 304 of the shell 306.

With reference to FIG. 3D, in still other embodiments, particles may be irradiated—to form the irradiated particles 302—without first or subsequently being encapsulated in matrix material 304. In these embodiments, the irradiated particle 302 may be formed of and include high-purity salts that have been neutron irradiated or Bremsstrahlung irradiated (which may be otherwise known in the art as “breaking radiation” or “deceleration radiation”) to provide a non-encapsulated particle 316.

Whether formed as the matrix-encapsulated particles 308 of FIG. 3A, the matrix-intermixed fragments 310 of FIG. 3B, the matrix-intermixed-and-encapsulated fragment 312 of FIG. 3C, the non-encapsulated particles 316 of FIG. 3D, or some other encapsulation/non-encapsulation format, the resulting isotope fragments 206 (FIG. 2A, FIG. 2B) may have a minimum dimension (e.g., length, width, diameter) of at least about 0.1 cm (e.g., within a range from about 0.1 cm to about 0.5 cm) so that—should the substrate material 204 of the tiles 100 become damaged and the isotope fragments 206 released from the tile 100—the isotope fragments 206 will be of a size that will facilitate locating and recovering the isotope fragment 206. In embodiments in which the irradiated particles 302 are encapsulated in the matrix material 304 (e.g., glass) prior to being incorporated into the substrate material 204, the presence of the matrix material 304 may also inhibit smearing or spreading of the irradiated material into neighboring materials (e.g., if the isotope fragments 206 are stepped on). Accordingly, the matrix material 304 (and the additional matrix material 314, if present) may provide additional protection should a tile 100 become torn or otherwise damaged in a way that exposes the isotope fragments 206.

Once the irradiated particles 302 have been formed and irradiated, the irradiated particles 302 are encapsulated by the substrate material 204 and formed into the tiles 100.

Features of any of the tiles 100, the irradiated particles 302, and/or the isotope fragments 206 may be tailored according to training, testing, or researching needs. For example, with regard to the composition of the irradiated particles 302, each irradiated particle 302 within the isotope fragments 206 of the tiles 100 may consist substantially of a single chemical element's isotopes (e.g., only europium isotopes, such as ¹⁵²Eu and/or ¹⁵⁴Eu). In other embodiments, more than one chemical element's isotopes (e.g., both europium isotopes and, e.g., selenium isotopes, such as ⁷⁵Se) may be included in each of one or more of the irradiated particles 302. Accordingly, the isotope composition of each isotope fragments 206 may be tailored.

In embodiments in which more than one irradiated particle 302 is included in a single isotope fragment 206 (e.g., as in the matrix-intermixed fragment 310 of FIG. 3B or the matrix-intermixed-and-encapsulated fragment 312 of FIG. 3C), the composition of the irradiated particles 302 within a single isotope fragment 206 may also be tailored according to training, testing, or researching needs. For example, the irradiated particles 302 of a single isotope fragment 206 may consist substantially of the same composition as one another. Alternatively, one or more irradiated particles 302 of a single isotope fragment 206 may have a different isotope composition than one or more other irradiated particles 302 of the isotope fragment 206.

As another example, each isotope fragment 206 within the tiles 100 may have substantially the same irradiated particle 302 composition, radioactivity level, and encapsulation form (e.g., either the matrix-encapsulated particle 308 form of FIG. 3A, the matrix-intermixed fragment 310 form of FIG. 3B, the matrix-intermixed-and-encapsulated fragment 312 form of FIG. 3C, the non-encapsulated particle 316 form of FIG. 3D, or some other form). Alternatively, one or more isotope fragments 206 of a given tile 100 may be of one irradiated particle 302 composition, radioactivity level, and/or encapsulation form while one or more other isotope fragments 206 of the tile 100 may be of a different irradiated particle 302 composition, radioactivity level, and/or encapsulation form.

Moreover, each tile 100 within a group of tiles 100 used in a facility may consist substantially of the same tile material and structure (e.g., the tile material 202 of FIG. 2A, the tile material 212 of FIG. 2B), and/or the same isotope fragment 206 composition and encapsulation form. In other embodiments, one or more tiles 100 may differ in any of these features from the corresponding features of one or more other tiles 100.

The radioactivity levels within a given tile 100 or group of tiles 100 may also be tailored. For example, in some embodiments, the isotope fragments 206 may be substantially evenly distributed throughout the whole area of a given tile 100. Therefore, the detectable activity level may be substantially consistent across the tile 100. In other embodiments, one or more areas of a single tile 100 may be formed to exhibit a greater activity level so as to simulate so-called “hot spots” within the tile 100 or within a group of the tiles 100. For example, one area of the tile 100 (or group of tiles 100) may include a greater amount (e.g., concentration) of the isotope fragments 206 than another area of the tile 100 (or group of tiles 100). Additionally or alternatively, one or more areas of the tile 100 (or group of tiles 100) may include isotope fragments 206 exhibiting greater radioactivity than the isotope fragments 206 in one or more other areas of the tile 100 (or group of tiles 100). In some tiles 100 (e.g., relatively larger or longer tiles 100), the tile 100 may be configured to include a gradient of radioactivity levels.

As a more particular example, the isotope fragments 206 within a given tile 100 may be in the form of the matrix-encapsulated particle 308 of FIG. 3A, and each may comprise, consist essentially of, or consist of Eu isotopes Eu-151 and/or Eu-15 encapsulated within the shell 306 formed of the matrix material 304, which may be sol-gel formed silica glass. A loading of about 100 mg/g (e.g., milligrams of irradiated particle 302 (e.g., Eu-151 and/or Eu-153 particles) per gram of glass matrix material 304) in 10 grams of activated sol-gel glass (e.g., the isotope fragments 206 in the form of the matrix-encapsulated particles 308 of FIG. 3A) would produce 88.8 MBq (2.4 mCi) of activity. The 88.8 MBq (2.4 mCi) activity would produce a dose-rate of about 1.1 mSv/hr (about 110 mrem/hr) at 30 cm from the isotope fragments 206. The 10 grams of activated sol-gel glass (e.g., the 10 grams of isotope fragments 206) may be distributed (e.g., evenly distributed throughout, distributed in a gradient throughout, or concentrated in hot spot areas) in the substrate material 204 (e.g., polymer material) of the tile 100.

Other features of the irradiated particles 302, the isotope fragments 206, and/or the tiles 100 that may be tailored may include the concentration of the radioactive material in the irradiated particles 302; the loading amount of the irradiated particles 302 in the matrix material 304 to form the isotope fragments 206; and the concentration, density, and distribution of the isotope fragments 206 in the tiles 100. Accordingly, the features of any of the irradiated particles 302, the isotope fragments 206, and the tiles 100 may be individually tailored according to training, testing, or research needs.

In some embodiments, an already fabricated tile 100 (FIG. 1A, FIG. 1B) may be further modified to adjust the activity and composition thereof. For example, in embodiments in which the tile 100 includes the tile material 202 of FIG. 2A, one or more additional layers of the tile material 202—with additional isotope fragments 206 embedded in the substrate material 204 (whether the same or a different substrate material 204 than in the tile material 202) may be fabricated on the previously-fabricated tile material 202, or may be fabricated separately and then attached to the previously-fabricated tile material 202. As another example, in embodiments in which the tile 100 includes the tile material 212 of FIG. 2B, an additional region of isotope fragments 206 may be encapsulated by an additional region of the substrate material 204 atop the previously-formed tile material 212. In still other embodiments, the later-fabricated and added on material may include an additional layer of the tile material 202 of FIG. 2A on the tile material 212 of FIG. 2B, or an additional region of the isotope fragments 206 of FIG. 2B on the tile material 202 of FIG. 2A with an additional region of the substrate material 204 (e.g., FIG. 2B) encapsulating the additional isotope fragments 206. In other embodiments, a new tile 100 may be fabricated and stacked (e.g., adhered) to the previously-fabricated tile 100.

The tiles 100 of embodiments of the disclosure facilitate a tailorable training, testing, or researching approach while also facilitating repositioning and reuse of the tiles 100. The tiles may be used in indoor or outdoor environments.

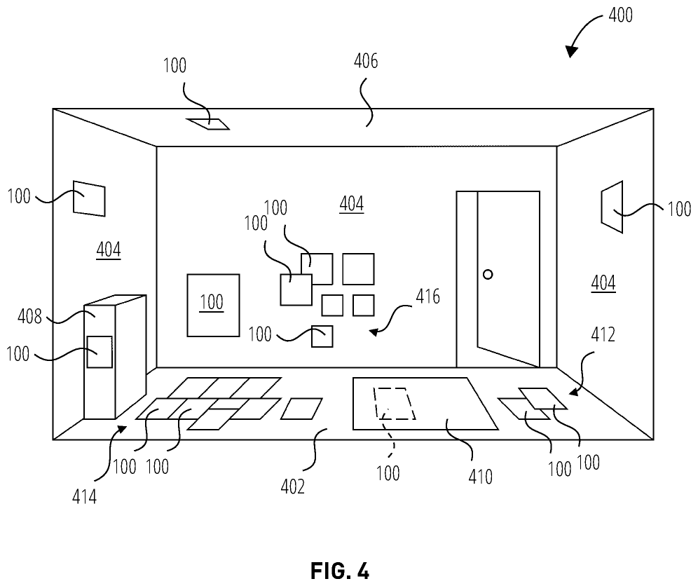

With reference to FIG. 4, schematically illustrated is a localized indoor training environment in the form of a room 400. One or more of the tiles 100 may be laid throughout the training venue (e.g., the room 400) to produce a realistic large-area contamination environment. The tiles 100 may be selectively placed on a floor 402, on walls 404, on a ceiling 406, and/or on furniture 408. Tiles 100 may be placed under other items in the room 400, such as under a rug 410. In some areas, multiple tiles 100 may be at least partially overlapped with one another, as with the illustrated overlapping tiles 412 in the room 400 of FIG. 4. In some areas multiple tiles 100 may be positioned in a close arrangement 414 with the tiles 100 directly adjacent one another. In other areas, tiles 100 may be positioned in a more spread-out arrangement 416. In some embodiments, different size tiles 100 may be included in the same room 400. Accordingly, the tiles 100 facilitate preparation of a facility, such as the room 400, with any number of different configurations.

Once the tiles 100 are selectively placed in the training, testing, or research environment (e.g., the room 400), the tiles 100 may be useful for the whole of the training, testing, or researching session—whether hours, days, weeks, or months—without an additional application of material, in contrast to liquid-sprayed surrogate solutions that may require several spray applications during a single hours-long training session.

The use of selectively positionable tiles 100 may facilitate a relatively-fast (e.g., rapid) reconfiguration of a simulated contamination event in a single training environment (e.g., the room 400). For example, a first training session may make use of the tiles 100 solely on the floor 402 of one room (e.g., the room 400) of the facility, and then a second training session may involve the first room (e.g., room 400) being wholly free of radioactive material while the tiles 100 have been moved into other rooms or the hallway, etc. In contrast, liquid-sprayed surrogate solutions may not facilitate fast and complete removal from the surfaces onto which they were initially sprayed.

Moreover, by providing the active isotopes throughout the area of the tile 100, if the tile 100 is so configured, and including multiple tiles 100 throughout a training environment, the combination of tiles 100 may better reflect a wide-spread contamination area than if using only multiple individual isotope fragments 206 selectively placed in the room. The latter scenario would more likely be detectable by appropriate instrumentation as multiple “hot spots” rather than a more evenly-distributed (e.g., homogeneous), large-area contamination with indiscriminate points of radioactivity. Furthermore, removing the radioactive material from the training environment may be significantly faster and easier by having all of the radioactive material encapsulated in the form of the tiles 100 compared to having to retrieve multiple, relatively-small individual isotope fragments 206. Therefore, upon completion of the training, the environment (e.g., the room 400) may be cleared of the isotope material quickly and efficiently by simply gathering the tiles 100 and removing the tiles 100 from the environment. With the isotope material isolated to the tiles 100, one is assured that—provided the number of retrieved tiles 100 matches the number of distributed tiles 100 and that no tile 100 has been broken open—all radioactive materials have been recovered and removed.

The recovered tiles 100 may then be stored and reused for future contamination training events. With moderate half-lives (e.g., half-lives within a range from about 1 year to about 30 years) the tiles 100 may be suitable for long-term use and re-use, providing a cost effective and safe method of contamination training. For example, while conventional single-use, surrogate isotope solutions may cost thousands of US dollars to produce and use, the production of the tiles 100 in accordance with embodiments of the disclosure may provide a training tool and a one-time cost that may be used for multiple years. Preparing replacement tiles 100 may not be necessary for several years.

While the disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated. Further, embodiments of the disclosure have utility with different and various devices and materials.

What is claimed is:

1. A structure for use in simulating radioactive contamination environments, the structure comprising:
fragments encapsulated within a substrate material, the fragments comprising radioactive isotopes with half-lives within a range from about one year to about thirty years.

2. The structure of claim 1, wherein the fragments comprise particles encapsulated within at least one matrix material, the particles comprising the radioactive isotopes.

3. The structure of claim 2, wherein each of the fragments comprises a shell comprising the at least one matrix material.

4. The structure of claim 2, wherein the at least one matrix material comprises silica.

5. The structure of claim 1, wherein the fragments comprise particles intermixed with at least one matrix material, the particles comprising the radioactive isotopes.

6. The structure of claim 1, wherein the fragments are embedded within the substrate material.

7. The structure of claim 1, wherein the fragments are disposed between a first region of the substrate material and a second region of the substrate material.

8. The structure of claim 1, wherein the substrate material comprises at least one polymer.

9. The structure of claim 8, wherein the at least one polymer of the substrate material comprises an aromatic polyamide.

10. The structure of claim 1, wherein the structure is substantially rectangular with a substantially planar upper surface.

11. The structure of claim 1, wherein the radioactive isotopes are selected from the group consisting of europium-152 (Eu-152) (¹⁵²Eu), europium-154 (Eu-154) (¹⁵⁴Eu), selenium-75 (Se-75) (⁷⁵Se), iridium-192 (Ir-192) (¹⁹²Ir), cesium-137 (Cs-137) (¹³⁷Cs), cobalt-60 (Co-60) (⁶⁰Co), and barium-133 (Ba-133) (¹³³Ba).

12. The structure of claim 11, wherein the radioactive isotopes of the fragments of the structure consist substantially of at least one of europium-152 and europium-154.

13. The structure of claim 1, wherein the fragments are distributed across the structure to provide a gradient of radioactivity across the structure.

14. The structure of claim 1, wherein at least some of the fragments have an individual minimum dimension of at least about 0.1 cm.

15. A method of forming a structure for use in simulating radioactive contamination environments, the method comprising:
encapsulating fragments within at least one substrate material, the fragments comprising radioactive isotopes with moderate half-lives.

16. The method of claim 15, further comprising, before the encapsulating, irradiating precursor fragments comprising particles of parent isotopes, of the radioactive isotopes, encapsulated or intermixed with at least one glass matrix material.

17. A method of simulating a radioactive contamination environment, the method comprising:
selectively placing, in a facility, multiple removable structures, each of the removable structures comprising fragments encapsulated within a substrate material, the fragments comprising radioactive isotopes with moderate half-lives.

18. The method of claim 17, not comprising spraying of any liquid solutions.

19. The method of claim 17, wherein selectively placing, in the facility, the multiple removable structures comprises selectively placing the multiple removable structures on a floor of an indoor facility.

20. The method of claim 17, further comprising, after a first session in the facility, removing the removable structures for subsequent repeating of the selective placement in another facility.
